(19) United States
(12) Patent Application Publication
(10) Pub. No.: US 2022/0098805 A1
(43) Pub. Date: Mar. 31, 2022

(54) SEALANT DISPENSING SYSTEM

(71) Applicant: RYNOWORX INDUSTRIES INC., New Dundee (CA)

(72) Inventors: Leigh KUHN, New Hamburg (CA); Eric HAISER, Toronto (CA)

(21) Appl. No.: 17/032,753

(22) Filed: Sep. 25, 2020

(51) Int. Cl. E01C 23/09; B05C 5/02; B05B 1/30; B05D 1/26; E01C 11/00; E01C 19/45

(52) U.S. Cl. CPC E01C 23/0973; B05C 5/0229; E01C 19/45; B05D 1/26; E01C 11/005; B05B 1/3046

(57) ABSTRACT

The following disclosure relates to portable systems for dispensing crack sealant and associated devices and methods. The systems and methods described herein may overcome operational inconveniences exhibited by existing systems and may facilitate the operation of such systems. In one embodiment, a walk-behind sealant dispensing system comprises a housing, a kettle disposed inside the housing for holding and dispensing sealant, and a poppet valve actuatable between a closed state and an open state to selectively cause sealant to be dispensed from the kettle. The poppet valve includes a valve body and a flange extending outwardly from the valve body. The flange includes a fastener hole formed therethrough. The poppet valve is attached to the housing via a fastener extending through the fastener hole and engaged with the housing.

### TECHNICAL FIELD

The disclosure relates generally to pavement maintenance, and more particularly to systems for melting, dispensing and/or applying crack sealant.

### BACKGROUND

Paved surfaces such as roads and driveways are prone to wear and tear over time. Surface deterioration may be caused, for example, by overloading, seepage, poor surface drainage, improper maintenance, improper design, and the weather. For example, cracks may form in paved surfaces and driveways due to application of stress from traffic and repeated freezing/thawing. If left untreated, the cracks can grow, cause roughness and eventually form potholes. Proper maintenance can maintain the quality and extend the useful life of paved surfaces.

One way to repair paved surfaces is to fill the cracks with sealant (crack fill) such as melted rubber, asphalt, or bitumen. Various machines have been developed for applying crack-filling material to roads and driveway surfaces. Such machines typically have a melting kettle, from which sealant in melted/liquid form is dispensed, and a torch for heating the kettle. Unfortunately, some existing machines can be cumbersome to operate and service. Improvement is desirable.

### SUMMARY

In one aspect, the disclosure describes a walk-behind sealant dispensing system comprising: a kettle for holding and dispensing sealant, the kettle having a front side facing a general direction of movement during operation of the system and a rear side opposite the front side; a handle for manually maneuvering the system by an operator, the handle being disposed behind the kettle at a position for handling by the operator in a standing position; and a poppet valve actuatable between a closed state and an open state to selectively cause sealant to be dispensed from the kettle.

In another aspect, the disclosure describes a crack sealant dispensing valve for a sealant dispensing system, the dispensing valve including: a valve body; a flange extending outwardly from the valve body, the flange including a fastener hole formed therethrough; a poppet movably received in the valve body to open and close a port of the dispensing valve; and a dispensing spout for fluid communication with the port.

In another aspect, the disclosure describes a sealant dispensing system comprising: a housing; a kettle for holding and dispensing sealant, the kettle disposed inside the housing; and a poppet valve actuatable between a closed state and an open state to selectively cause sealant to be dispensed from the kettle, the poppet valve including a valve body and a flange extending outwardly from the valve body, the flange including a fastener hole formed therethrough, the poppet valve being attached to the housing via a fastener extending through the fastener hole and engaged with the housing.

In another aspect, the disclosure describes a method of making a dispensing valve for a sealant dispensing system. The method comprises: receiving a valve body and an upstream portion of a dispensing spout attached to the valve body; attaching a downstream spout portion of the dispensing spout to the upstream spout portion; and installing a movable valve member inside the valve body.

In another aspect, the disclosure describes a walk-behind sealant dispensing system comprising: a kettle for holding and dispensing sealant, the kettle having a front side facing a general direction of movement during operation of the system and a rear side opposite the front side; a handle for manually maneuvering the system by an operator, the handle being disposed behind the kettle at a position for handling by the operator in a standing position; and an indicator operatively coupled to a sensor and configured to indicated a value of a parameter sensed by the sensor and associated with the operation of the system, the indicator being disposed closer to the handle than to the kettle.

In another aspect, the disclosure describes a walk-behind sealant dispensing system comprising: a kettle for holding and dispensing sealant; a dispensing spout having a spout outlet for dispensing sealant from the kettle; and a spreader for spreading the sealant dispensed from the spout outlet, the spreader being movable between a stowed position where the spreader closes the spout outlet and a deployed position where the spreader opens the spout outlet.

In another aspect, the disclosure describes a walk-behind sealant dispensing system comprising: a kettle for holding and dispensing sealant, the kettle having a front side facing a general direction of movement during operation of the system and a rear side opposite the front side; a handle for manually maneuvering the system by an operator, the handle being disposed behind the kettle at a position for handling by the operator in a standing position; and a valve actuatable between a closed state and an open state to selectively cause sealant to be dispensed from the kettle, the valve being biased toward the closed position by a spring, a biasing force provided by the spring being adjustable.

In another aspect, the disclosure describes a walk-behind sealant dispensing system comprising: a kettle for holding and dispensing sealant, the kettle having a front side facing a general direction of movement during operation of the system and a rear side opposite the front side; and a handle for manually maneuvering the system by an operator, the handle being disposed behind the kettle at a position for handling by the operator in a standing position, the position of the handle being adjustable relative to the kettle.

In another aspect, the disclosure describes a walk-behind sealant dispensing system comprising: a frame; a kettle for holding and dispensing sealant, the kettle attached to the frame and having a front side facing a general direction of movement during operation of the system and a rear side opposite the front side; a handle for manually maneuvering the system by an operator, the handle attached to the frame and being disposed behind the kettle at a position for handling by the operator in a standing position; and a fuel burner for heating the kettle; a restraint for releasably attaching a fuel tank to the frame; and a tightener operable to adjust a tension on the restraint.

In another aspect, the disclosure describes a walk-behind sealant dispensing system comprising: a housing having a front side facing a general direction of movement during operation of the system and a rear side opposite the front side, the housing having an opening defined on the rear side of the housing; a kettle for holding and dispensing sealant, the kettle being disposed inside the housing; and a burner for heating the kettle, the burner being disposed inside the housing and being accessible via the opening defined in the housing.

In another aspect, the disclosure describes a walk-behind sealant dispensing system comprising: a frame; a kettle for holding and dispensing sealant, the kettle attached to the frame, the kettle having a front side facing a general direction of movement during operation of the system and a rear side opposite the front side; a handle for manually maneuvering the system by an operator, the handle being disposed behind the kettle at a position for handling by the operator in a standing position; and a first arm and a second arm laterally spaced apart from the first arm, the first and second arms interconnecting the handle and the frame, the first and second arms each having a proximal portion attached to the frame and a distal portion distal of the frame, the distal portions of the first and second arms each having a channel configuration.

In another aspect, the disclosure describes a plate or sheet having a graphical or textual indication defined thereon. The plate or sheet comprising: an unperforated region outside an outline of the graphical or textual indication; and a perforated region inside the outline of the visual indication, the perforated region including a plurality of spaced apart perforations defining a honeycomb pattern filling an area inside the outline of the graphical or textual indication.

In another aspect, the disclosure describes a sealant dispensing system comprising:
a housing including a housing wall having a vent defined therein, the vent having an outline of a graphical or textual indication, the housing wall including:
   an unperforated region outside the outline of the graphical or textual indication; and
   a perforated region inside the outline of the graphical or textual indication, the perforated region including a plurality of spaced apart perforations defining a honeycomb pattern filling an area inside the outline of the graphical or textual indication;
a kettle for holding and dispensing sealant, the kettle being disposed inside the housing; and
a burner for heating the kettle, the burner being disposed inside the housing.

In another aspect, the disclosure describes a walk-behind sealant dispensing system comprising: a kettle for holding and dispensing sealant, the kettle having a front side facing a general direction of movement during operation of the system and a rear side opposite the front side; a lid disposed over the kettle, the lid pivotable about a hinge line between a closed position and an open position, the hinge line transverse to the general direction of movement and disposed closer to the rear side of the kettle than to the front side of the kettle; and a handle for manually maneuvering the system by an operator, the handle being disposed behind the kettle.

In another aspect, the disclosure describes a walk-behind sealant dispensing system comprising: a kettle for holding and dispensing sealant, the kettle having a front side facing a general direction of movement during operation of the system and a rear side opposite the front side, the front side of the kettle having a front top edge and the rear side of the kettle has a rear to edge, the front top edge of the kettle being lower than the rear top edge of the kettle during operation of the system; and a handle for manually maneuvering the system by an operator, the handle being disposed behind the kettle.

In another aspect, the disclosure describes a walk-behind sealant dispensing system comprising: a kettle for holding and dispensing sealant, the kettle having a front side facing a general direction of movement during operation of the system and a rear side opposite the front side; a rear handle for manually maneuvering the system by an operator, the handle being disposed behind the kettle; and a front handle disposed in front of the kettle to facilitate lifting of the system.

In another aspect, the disclosure describes a sealant dispensing system comprising: a kettle for holding and dispensing sealant; a burner for heating the kettle; and a quantity indicator indicating a quantity of sealant inside the kettle, the quantity indicator including an elongated member disposed inside the kettle and extending at least partly between a top and a bottom of the kettle, the elongated member including one or more external markings indicative of the amount of sealant inside the kettle, the elongated member housing a temperature probe in fluid communication with contents of the kettle.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective front view of an exemplary sealant dispensing system with a kettle lid closed;

FIG. 2 is a side elevation view of the sealant dispensing system together with a human operator;

FIG. 3 is an enlarge perspective view of an exemplary distal portion of an arm of a handle assembly of the sealant dispensing system;

FIG. 4 is an enlarge perspective view of an exemplary proximal portion of an arm of the handle assembly of the sealant dispensing system;

FIG. 5 is an enlarged view of region R5 of FIG. 2 showing an adjustability of the handle of the sealant dispensing system;

FIG. 6 is a perspective view of an exemplary front wheel and handle of the sealant dispensing system;

FIG. 7 is a perspective view of an exemplary instrument panel of the sealant dispensing system;

FIG. 8 is a perspective front view of the sealant dispensing system of FIG. 1 with the kettle lid open;

FIG. 9 is an enlarged view of an exemplary latch for securing the kettle lid in a closed position;

FIG. 10 is a perspective cross-sectional view of part of the sealant dispensing system taken along line 10-10 of FIG. 8;

FIG. 11 is a perspective rear view of the sealant dispensing system;

FIG. 12 is an enlarged perspective rear view showing an exemplary access panel and burner of the sealant dispensing system;

FIG. 13 is an enlarged view of region R13 of FIG. 2;

FIGS. 14A and 14B are perspective views of an exemplary dispensing valve of the sealant dispensing system shown in the closed and open positions respectively;

FIGS. 15A and 15B are perspective views of an exemplary spreader of the sealant dispensing system shown in two different configurations;

FIG. 16 is a perspective view of part of an exemplary handle and valve control of the sealant dispensing system;

FIGS. 17A and 17B are perspective cross-sectional views of the dispensing valve taken along line 10-10 of FIG. 8 shown in the closed and open positions respectively;

FIGS. 18A and 18B are schematic side elevation views of a dispensing spout and spreader respectively closing and opening the dispensing spout;

FIG. 19 is a flowchart of a method of making a dispensing valve;

FIG. 20 is a perspective view of part of the dispensing valve; and

FIG. 21 is an enlarged view of region R20 of FIG. 13.

### DETAILED DESCRIPTION

The following disclosure relates to portable systems for dispensing crack sealant and associated devices and methods. The systems described herein may be melters and applicators used to melt crack sealant, dispense the crack sealant and apply the crack sealant to fill cracks in paved or other surfaces with the melted sealant. The systems described herein may be referred to as “push melter/applicators”. In some embodiments, the systems and methods described herein may overcome operational inconveniences exhibited by existing systems and may facilitate the operation of such systems. In some embodiments, aspects of the following disclosure may improve the operation of sealant dispensing systems by reducing down time, improving productivity and reducing operator fatigue. Aspects of this disclosure may define improvements to existing sealant dispensing systems such as described in U.S. Pat. No. 9,739,021 entitled METHOD AND APPARATUS FOR SEALING CRACKS, which is incorporated herein by reference. Sealant dispensing systems may be fitted with one or several of the aspects described herein.

The systems described herein may be used with sealant made of a material or a combination of materials appropriate to fill cracks formed in a paved or concrete surface such as a road or driveway. For example, the sealant may be rubber, asphalt, or bitumen. In some examples, the sealant may be Dura-Fill HS™ or Dura-Fill PL™ sealant produced by P&T Products Inc. of Sandusky, Ohio, USA; Nuvo Elite B™ produced by Maxwell Products Inc. of Salt Lake City, Utah, USA; or Superflex HT™ produced by Crafco Inc. of Chandler, Ariz., USA. In other examples, the sealant may be a suitable asphalt sealant or non-asphalt sealant.

Aspects of various embodiments are described through reference to the drawings.

The term “attached” or “coupled” may include both direct attachment/coupling (in which two elements that are coupled to each other contact each other) and indirect coupling (in which at least one additional element is located between the two elements). The term “substantially” as used herein may be applied to modify any quantitative representation which could permissibly vary without resulting in a change in the basic function to which it is related.

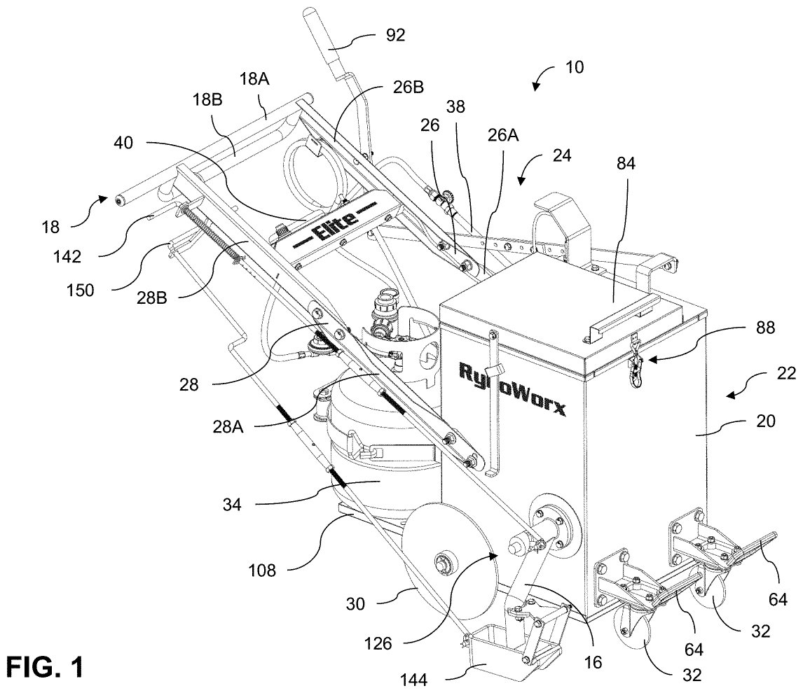

FIG. 1 is a perspective front view of an exemplary sealant dispensing system 10 (referred hereinafter as “system 10”).

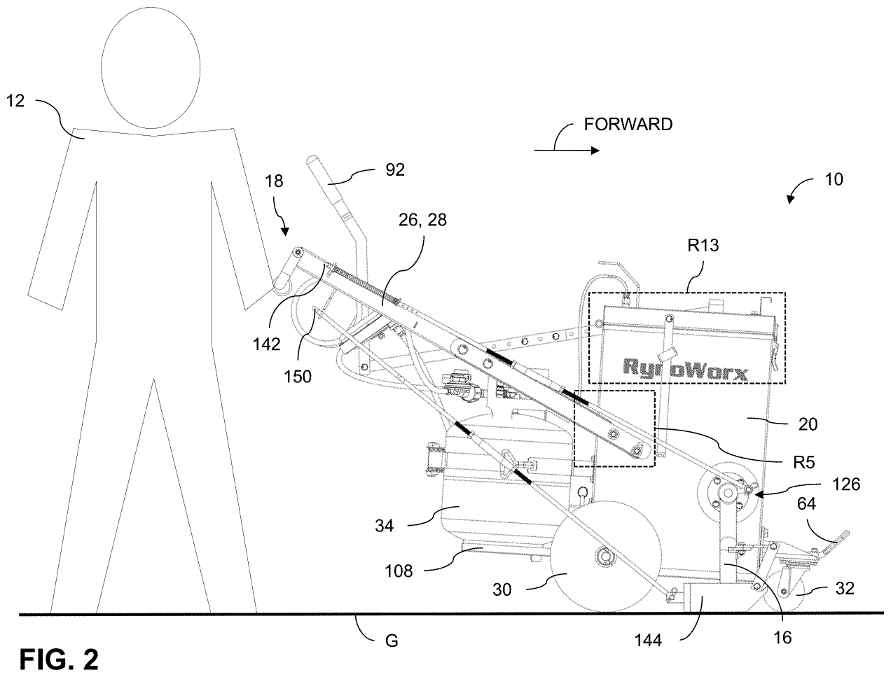

FIG. 2 is a side elevation view of system 10 together with human operator 12. In reference to FIGS. 1 and 2, it is understood that embodiments of system 10 may include additional or fewer components than those illustrated herein. In various embodiments, system 10 may be configured to melt crack sealant that is in solid or semi-solid form, dispense the crack sealant and apply (e.g., spread) the crack sealant. However, embodiments of system 10 may be configured to dispense crack sealant that is already in liquid form and that may not require heating and melting. Aspects of the systems described herein may be applicable to other types of sealant dispensing systems.

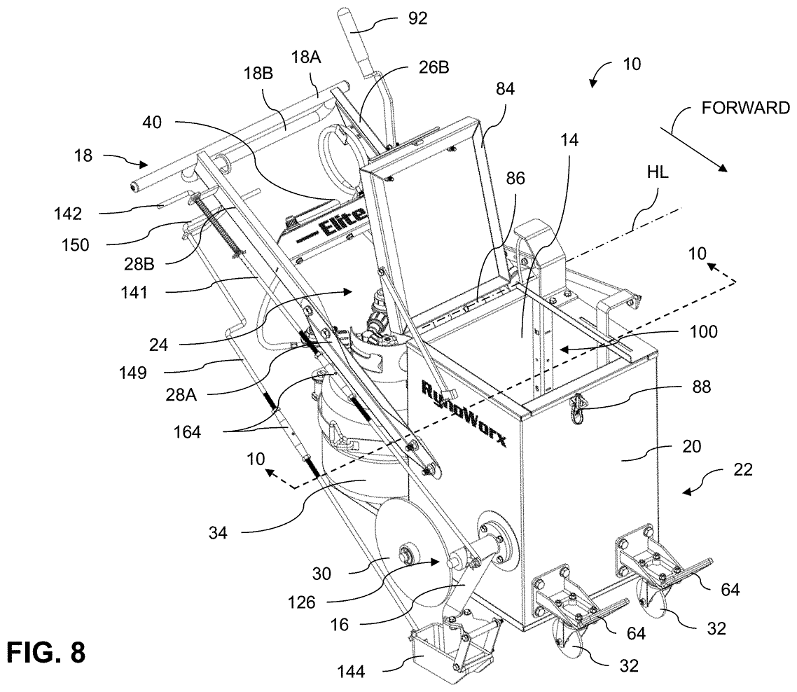

System 10 may include kettle 14 (shown in FIG. 8) in which sealant may be melted and contained until dispensed via spout 16. System 10 may have a walk-behind configuration where human operator 12 (shown in FIG. 2) may stand behind system 10 and maneuver (e.g., push, pull, tilt, lift and/or steer) system 10 so as to guide system 10 along a crack that is being filled by sealant dispensed via spout 16.

System 10 may include handle 18 that may facilitate the manual maneuvering of system 10 by operator 12 in a standing position. Handle 18 may be attached to kettle 14 via a suitable frame such as any chassis, bracket or other suitable support structure. In some embodiments, housing 20 may serve as such frame to which kettle 14 and handle 18 may be mounted.

As shown in FIG. 2, system 10 may have a general forward direction of movement along which system 10 is propelled during operation (see arrow labelled “FORWARD”). The forward direction indicated may be a principal direction of movement during operation but system 10 may be steered laterally to deviate from the forward direction to follow a non-linear trajectory of a crack for example. It is also understood that, in some embodiments, system 10 could be operable to seal cracks by moving system 10 in a backward direction opposite the indicated forward direction. System 10 may be moved in the forward direction by pushing on handle 18 and moved in the backward direction by pulling on handle 18 for example. Housing 20 (and kettle 14) may have front side 22 facing the general direction of movement during operation of system 10 and rear side 24 opposite front side 22.

Handle 18 may be disposed behind housing 20 and kettle 14 to facilitate the walk-behind configuration of system 10. Handle 18 may be disposed higher from ground G than a top of housing 20 and kettle 14. Ground G may be a paved or concrete surface. Handle 18 may include one or more handle bars 18A, 18B. Handle bars 18A and 18B may be substantially parallel. First handle bar 18A may be disposed higher than second handle bar 18B to cater to operators 12 of different heights.

Handle 18 may be part of a handle assembly including one or more arms 26, 28 that interconnect handle 18 to housing 20 or other frame of system 10. The handle assembly described and shown herein may be suitable for use on other types of portable and mobile walk-behind appliances. The handle assembly may be made of a suitable metallic material such as steel for example. Handle 18 may be attached to arms 26, 28 by fastening or welding. First arm 26 and second arm 28 may be laterally spaced apart from each other. First arm 26 may have proximal portion 26A attached to housing 20, and distal portion 26B that is distal of housing 20. In various embodiments, proximal portion 26A and distal portion 26B may be a single component or separate components that are releasably attached together using one or more fasteners for example. In the illustrated embodiment, first arm 26 and second arm 28 have a substantially identical construction except for being arranged as mirror images of each other as part of the handle assembly. First arm 26 and second arm 28 may be disposed to be substantially parallel to each other. Handle 18 may extend between distal portion 26B of first arm 26 and distal portion 28B of second arm 28.

System 10 may include one or more ground-engaging members, such as wheels or endless tracks for example, that facilitate the movement of system 10 along ground G. Such ground-engaging members may include one or more rear wheels 30 and one or more front wheels 32. Rear wheels 30 may have a non-variable (i.e., fixed) rotation axis and front wheels 32 may have the ability to swivel in order to facilitate steering of system 10. For example, front wheels 32 may be swivel casters. Alternatively, front wheels 32 could have a non-variable rotation axis and rear wheels 30 could have the ability to swivel. Front wheels 32 may be mounted in front of housing 20 and kettle 14. System 10 may be manually portable and maneuverable by a single human operator 12.

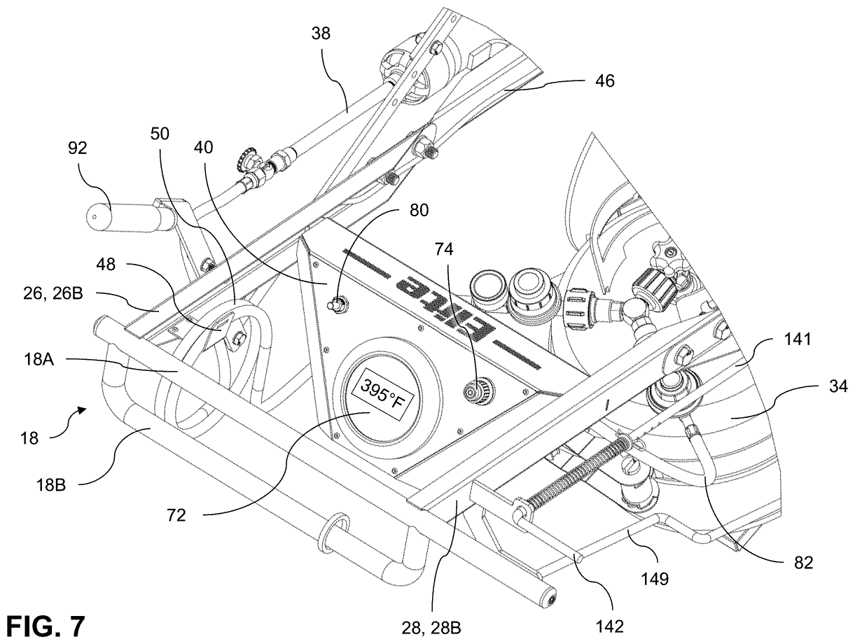

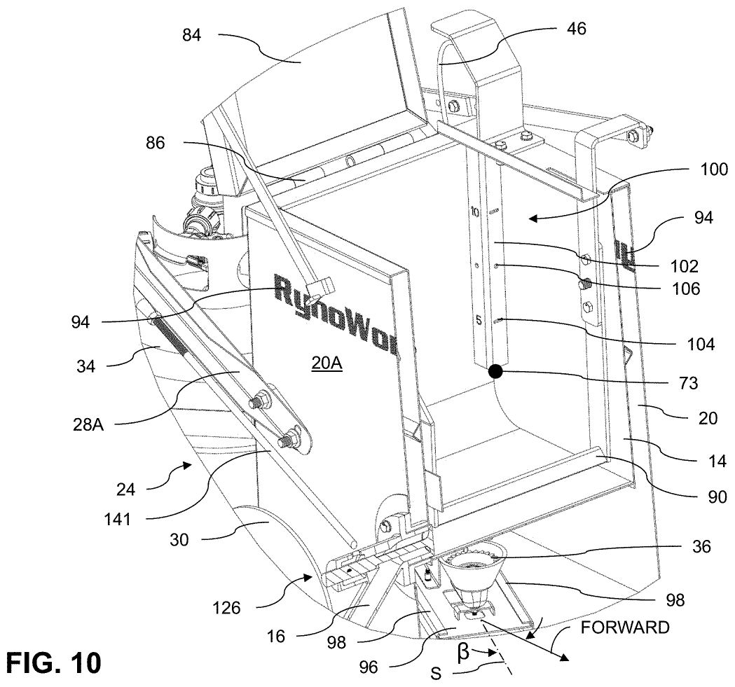

During use, system 10 may include fuel tank 34 containing a pressurized fuel such as propane or natural gas for supplying burner 36 (shown in FIG. 10) for heating kettle 14. Burner 36 may be disposed inside of housing 20 and under kettle 14. In some embodiments, system 10 may also include torch 38 (shown more clearly in FIG. 7) that may be supported by the handle assembly and/or housing 20 and that may be deployed and utilized as needed. Fuel tank 34 may be secured to system 10 and may be disposed behind housing 20. Fuel tank 34 may be operatively coupled to burner 36 and torch 38 via suitable hose(s), flow or pressure regulator(s) and valve(s).

As described in more details below, system 10 may, in some embodiments, include instrument panel 40 (dashboard) disposed closer to handle 18 than to housing 20. Instrument panel 40 may be supported by and extend between first arm 26 and second arm 28.

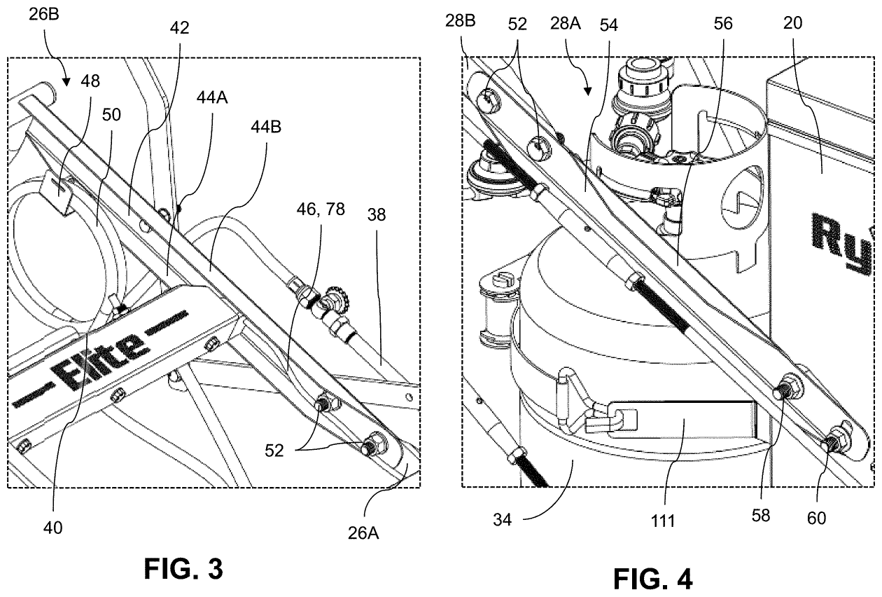

FIG. 3 is an enlarge perspective view of distal portion 26B of a first arm 26 of the handle assembly. Distal portions 26B and 28B may have a substantially identical construction. Distal portion 26B may have a channel configuration. In some embodiments, part of distal portion 26B may have a parallel flange channel configuration. For example, distal portion 26B may include web 42 and flanges 44A, 44B extending from web 42 toward second arm 28. Web 42 and flanges 44A, 44B may define a C-shaped channel of distal portion 26B opening toward second arm 28.

The (e.g., three-sided, open) channel configuration of distal portions 26B, 28B may structurally efficient in terms of providing relatively high strength and stiffness relative to weight. For example, the channel configuration may also provide desirable resistance to bending of distal portion 26B. The channel configuration may also permit one or more connections 46 to be routed inside the channel(s) and be relatively protected/shielded from impact with other objects. Such connections 46, may include (e.g., rubber) fuel hose(s), other conduits, and electric wires for example. For example, connection 46 may operatively connect an indicator disposed on instrument panel 40 with an associate sensor located elsewhere on system 10.

In embodiments of system 10 including torch 38, first arm 26 may have hook 48 attached thereto for supporting hose 50 associated with torch 38. Hook 48 may be fastened or welded to distal portion 26B. Distal portion 26B may be fastened to proximal portion 26A via one or more fasteners such as bolts 52.

FIG. 4 is an enlarge perspective view of proximal portion 28A of second arm 28 of the handle assembly. Proximal portions 26A and 28A may have a substantially identical construction. Proximal portion 28A of second arm 28 may include web 54 and flange 56 extending from web 54 away from first arm 26. Flange 56 may extend only over a middle portion of proximal portion 28A. Flange 56 may also provide structural resistance to bending of proximal portion 28A. Flange 56 may be disposed on upper or lower sides of web 54. In some embodiments, flange 56 may be disposed on the upper side of web 54 and another flange (not shown) may be disposed on the lower side of web 54. Alternatively, the lower side of web 54 may be devoid of such other flange.

Proximal portions 26A, 28A and distal portions 26B, 28B may be manufactured by cutting, bending and drilling sheet metal pieces made from steel, aluminum alloy or other suitable material(s).

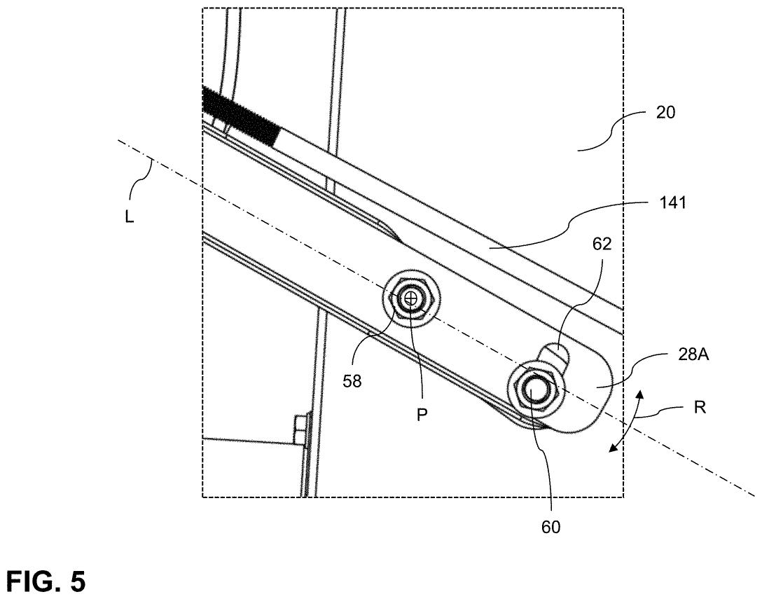

FIG. 5 is an enlarged view of region R5 of FIG. 2 showing an adjustability of handle 18 of system 10. In some embodiments of system 10, a height of handle 18 from ground G may be adjustable to cater to operators 12 of different heights. Adjustment of handle 18 may be achieved by rotation of arms 26, 28 of the handle assembly along arrow R relative to housing 20 (and relative to kettle 14) or to other frame to which arms 26, 28 may be adjustably attached.

FIG. 5 shows the adjustable attachment of proximal portion 28A of second arm 28 to housing 20. Proximal portion 26A of first arm 26 may be adjustably attached to an opposite lateral side of housing 20 in a substantially identical manner so that both arms 26, 28 may adjusted in unison. For example, proximal portion 28A may be pivotaly adjustable relative to housing 20. Proximal portion 28A may be attached to housing 20 at first attachment point 58 and second attachment point 60 that are spaced apart along a longitudinal axis L of proximal portion 28A. First attachment point 58 may define pivot axis P for rotation of second arm 28 relative to housing 20. First attachment point 58 may be established by way of a threaded stud secured to and extending outwardly from housing 20 through a hole formed in proximal portion 28A, and a nut threaded onto the threaded stud to secured proximal portion 28A. Alternatively, first attachment point 58 may be established by a bolt extending through a hole formed in proximal portion 28A and engaged with a corresponding threaded hole formed in housing 20. Alternatively, first attachment point 58 may be established by a pin secured to and extending outwardly from housing 20 through a hole formed in proximal portion 28A.

Second attachment point 60 may be established by way of a threaded stud secured to and extending outwardly from housing 20 through a slotted hole (referred hereinafter as “slot 62”) formed in proximal portion 28A, and a nut threaded onto the threaded stud to secured proximal portion 28A. Alternatively, second attachment point 58 may be established by a bolt extending through slot 62 formed in proximal portion 28A and engaged with a corresponding threaded hole formed in housing 20. When the nuts and/or bolts at first attachment point 58 and at second attachment point 60 are loosened, slot 62 may permit a range of rotational movement of second arm 28 relative to pivot point P. Once second arm 28 is adjusted to achieve the desired position of handle 18, the nuts and/or bolts at first attachment point 58 and second attachment point 60 may be tightened to secure the position of proximal portion 28A relative to housing 20.

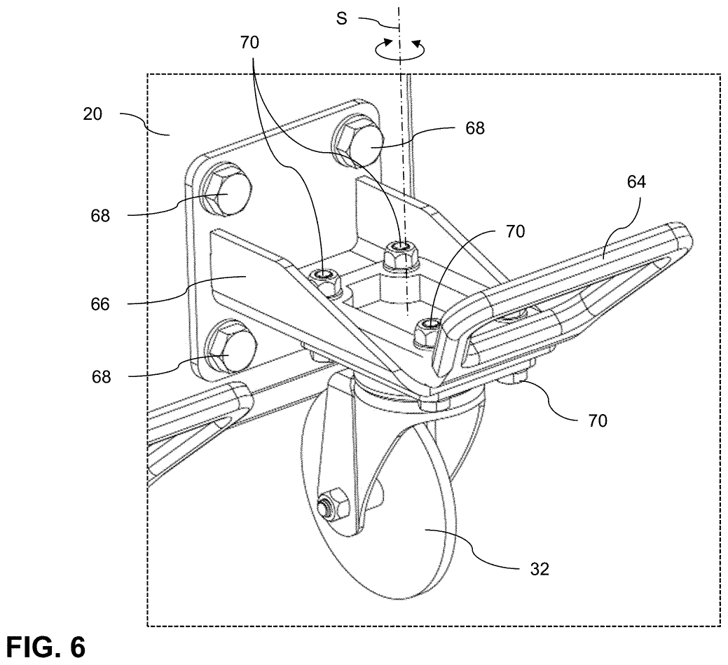

FIG. 6 is an enlarged perspective view of an exemplary front wheel 32 and front handle 64 of system 10. Front wheel 32 may be a swivel caster and may be rotatable about swivel axis S to facilitate steering of system 10. In various embodiments, front wheel 32 may be disposed under housing 20 or in front of housing 20. For example, front wheel 32 may be attached to housing 20 or other frame of system 10 via bracket 66. Bracket 66 may be secured to a front side of housing 20 via one or more bolts 68 or by welding. Front wheel 32 may be secured to a bottom side of bracket 66 via one or more bolts 70.

Front handle 64 may be provided to facilitate lifting of system 10 for loading system 10 into a truck bed or trailer for example. Front handle 64 may be disposed in front of housing 20 (and kettle 14). The use of rear handle 18 and front handle(s) 64 may facilitate a two-person lift of system 10 by having one person lifting using rear handle 18 and the other person lifting using front handle(s) 64.

Front handle 64 may be attached to housing 20 or other frame of system 10. In some embodiments, front handle 64 may attached to a front wall of housing 20 either directly or via the same bracket 66 used to attach front wheel 32 to housing 20. For example, front handle 64 may be secured to a top side of bracket 66 while front wheel 32 is secured to an opposite bottom side of bracket 66. In some embodiments, the same bolts 70 may be used to secure front wheel 32 and front handle 64 to the same bracket 66. In some embodiments, system 10 may include two sets of front wheels 32 and handles 64 laterally spaced apart on front side 22 of system 10. Alternatively, system 10 may include a single set of front wheel 32 and handle 64 centrally located on front side 22 of system 10. Front handle(s) 64 may, for example, be made of an aluminum alloy or steel and may be manufactured by casting or machining.

FIG. 7 is a perspective view of an exemplary instrument panel 40 of system 10. Instrument panel 40 may disposed between arms 26, 28 and be attached (e.g. fastened or welded) to one or both arms 26, 28. Instrument panel 40 may be disposed closer to handle 18 than to housing 20 and may include one or more instruments that facilitates the operation of system 10 and increases operator awareness of the state of system 10. For example, instrument panel 40 may include temperature indicator 72 operatively coupled to temperature probe 73 (shown in FIG. 10) and configured to indicate a value of a temperature of the sealant inside kettle 14 substantially in real time. Temperature indicator 72 may be mechanically or battery operated and may include an analog or digital readout of the temperature value. In some embodiments, temperature indicator 72 may be part of a bimetal thermometer. Instrument panel 40 may include other types of indicators (e.g., digital or analog gages) to indicate other parameters (e.g., flame ON/OFF status, amount of sealant remaining inside kettle 14, burner run time, distance (e.g., linear feet) travelled by system 10 with valve 126 open) associated with the operation of system 10.

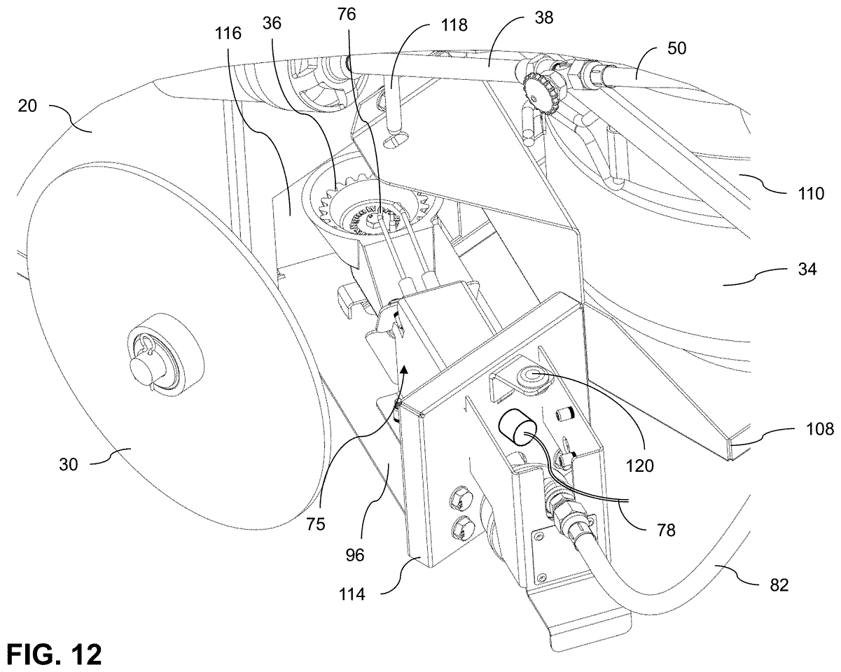

System 10 may include one or more manual controls (e.g., knobs, push buttons, switches) disposed on instrument panel 40. For example, igniter button 74 may be operatively (e.g., electrically) coupled to igniter 75, which may include igniter electrode(s) 76 (shown in FIG. 12) via ignition wire 78 (shown in FIG. 12). Igniter button 74 may cause igniter electrode(s) 76 to generate sparks during ignition of burner 36. Igniter button 74 may be part of a piezoelectric or another type of ignition system. In some embodiments, igniter 75 may be of a same type used on some gas cooking grills.

System 10 may include burner start button 80 that may be operatively coupled to a valve allowing fuel to burner 36 via fuel hose 82. Burner start button 80 may be operatively disposed between burner 36 and fuel tank 34 along fuel hose 82. Depressing burner start button 80 may serve to supply fuel to burner 36 during ignition and then, once ignition has been established, fuel flow to burner 36 may be controlled by way of a suitable flow or pressure regulator. During ignition, burner start button 80 and igniter button 74 may both be depressed simultaneously to supply fuel and sparks to burner 36 until sustained combustion is established at burner 36. The proximity of burner start button 80 and igniter button 74 to handle 18 such as on instrument panel 40, may promote operator safety and facilitate the lighting of burner 36 by eliminating the need for operator 12 to crouch on ground G to get close to burner 36. The distal location of instrument panel 40 from kettle 14 may also reduce the likelihood of one or more instruments being damaged from exposure to heat, melted sealant, or from impact with other objects.

In some embodiments, temperature indicator 72 and temperature probe 73 may be part of a closed loop temperature controller for controlling the temperature inside of kettle 14. For example, such temperature controller may be operatively coupled to a suitable flow or pressure regulator for adjusting fuel delivery to burner 36 based on a difference between an actual temperature and a desired set point temperature inside kettle 14. For example, system 10 may include a digital temperature controller or a mechanical thermostatic device for example.

FIG. 8 is a perspective front view of system 10 with lid 84 of kettle 14 shown in the open position. Lid 84 may be opened to allow sealant, in solid or liquid form, to be loaded into kettle 14. During operation, lid 14 may be closed to hinder heat loss from kettle 14 and also hinder melted sealant from exiting the top of kettle 14 during movement of system 10. Lid 84 may be disposed over kettle 14 and be pivotable about hinge line HL by way of hinge 86 between a closed position (shown in FIG. 1) and the open position. Hinge line HL may be oriented transversely to the general forward direction of movement shown in FIG. 8. Hinge line HL may be disposed closer to a rear side of kettle 14 than to a front side of kettle 14. For example, lid 84 may be attached to a rear portion of housing 20 via one or more hinges 86. The rearward opening of lid 84 may facilitate the loading of sealant into kettle 14 from the front, left side or right side of housing 20. The ability to fill kettle 14 from multiple sides may facilitate filling kettle 14 from a larger kettle disposed in a trailer or a truck bed. In the open position, lid 84 may also shield components disposed behind housing 20 from inadvertent spillage or splashing of liquid sealant for example.

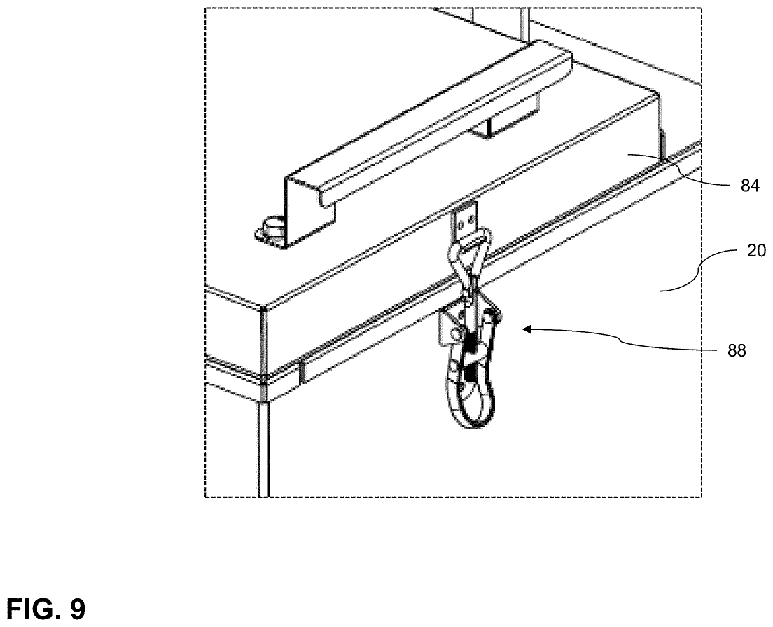

FIG. 9 is an enlarged view of latch 88 for securing lid 84 in the closed position. Latch 88 may be manually actuatable and may be lockable. Latch 88 may be disposed on a front side of housing 20 or, on a left or right side of housing 20 in other embodiments. Latch 88 may be a draw latch operating on the principle of drawing two items together using tension. It is understood that other means may be suitable for holding lid 84 in the closed position. Holding lid 84 in the closed position may be useful to prevent spillage when system 10 is maneuvered during use, during lifting or transport of system 10.

FIG. 10 is a perspective cross-sectional view of part of system 10 taken along line 10-10 of FIG. 8. FIG. 10 shows an interior of kettle 14, which may be disposed inside of housing 20. In some embodiments, system 10 may include agitator 90 which may be actuated in a reciprocating manner to cause mixing of the sealant disposed inside kettle 14. Agitator 90 may be manually actuated by operator 12 using agitator handle 92 (shown in FIG. 8) that may be proximal to handle 18 and mechanically linked to agitator 90.

Burner 36 may be disposed inside of housing 20 and under kettle 14. Housing 20 may shield burner 36 from the wind and consequently reduce the likelihood of flameouts. The location of burner 36 and configuration of housing 20 described herein may promote burner 36 staying lit during operation of system 10. A gap may be disposed between kettle 14 and housing 20 to provide a some thermal insulation of kettle 14 from the outside ambient air and hinder heat loss from kettle 14. Housing 20 may also provide some protection of operator 12, other person(s) or objects from direct contact with relatively hot walls of kettle 14 during use. Combustion gas generated by burner 36 may be exhausted from housing 20 via one or more vents 94 defined in one or more walls 20A of housing 20. As explained further below, vents 94 may include perforations through the walls of housing 20 to permit the passage of combustion gas.

Burner 36 may be disposed substantially centrally under kettle 14 and oriented upwardly. Burner 36 may be movably engaged, via platform 96, to one or more tracks 98 that are attached to housing 20. For example, burner 36 may be mounted to platform 96 which may be in sliding engagement with tracks 98 so that burner 36 and platform 96 may be movable as a unit along direction S defined by tracks 98. The movement of burner 36 along tracks 98 may facilitate access to burner 36 via rear side 24 of housing 20 as explained further below. Direction S may be oriented obliquely to the general forward direction of movement of system 10. In various embodiments, direction S may be oriented at an angle β of between 15° and 35° of the general forward direction of movement. In some embodiments, direction S may be oriented at an angle β of about 25° of the general forward direction of movement.

In some embodiments, system 10 may include quantity indicator 100 indicating a remaining quantity of sealant inside kettle 14. Quantity indicator 100 may include an elongated member 102 disposed inside kettle 14 and extending at least partly between a top and a bottom of kettle 14. Elongated member 102 may include one or more external markings 104 visually indicative of the quantity of sealant inside kettle 14. Markings 104 may define graduations indicating points on a visual linear scale extending along elongated member 102. Markings 104 may be accompanied by numerical indications indicative of associated quantities (e.g., litres, gallons, equivalent linear feet of sealant to be applied, equivalent kilograms or pounds) of sealant inside kettle 14. The markings 104 may provide a useful indication when refilling kettle 14 to prevent over filling. Quantity indicator 100 may be disposed in an internal corner of kettle 14 defined by an intersection of two adjacent side walls of kettle 14.

Elongated member 102 may be tubular and have a hollow interior that is in fluid communication with the interior of kettle 14 so that melted sealant may enter the interior of elongated member 104 via one or more apertures 106 during operation. In some embodiments, elongated member 102 may also serve as a protective sheath for at least part of temperature probe 73 disposed in fluid communication with contents of kettle 14. Temperature probe 73 may be operatively coupled to indicator 72 disposed on instrument panel 40 via wired connection 46. Temperature probe 73 may be disposed near an open lower end of (i.e., lower aperture) in elongated member 102. Connection 46 may be routed along the interior of elongated member 102. Temperature probe 73 may include any suitable type of temperature sensor such as a thermocouple, a resistance temperature detector or a temperature responsive capillary tube, for example.

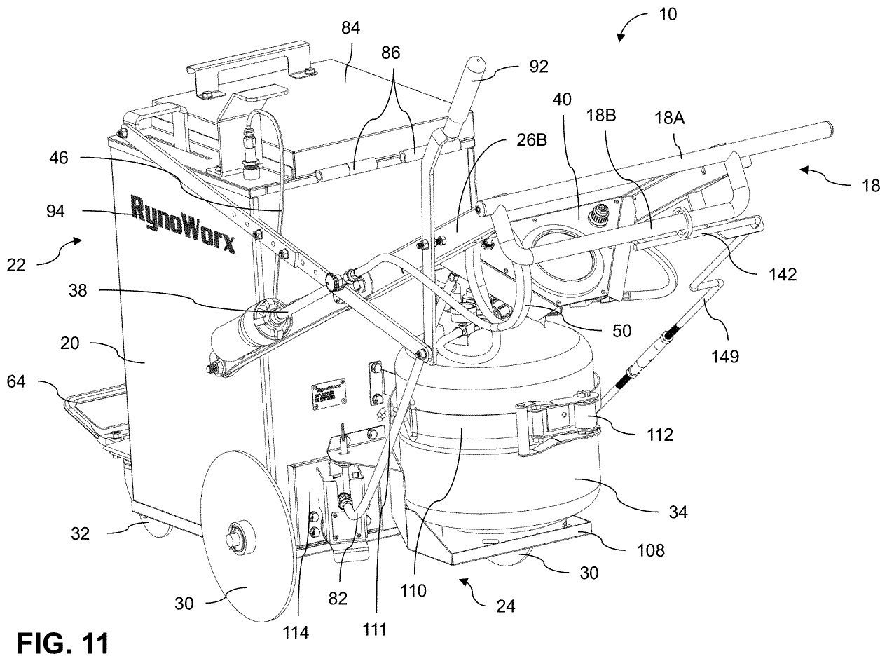

FIG. 11 is a perspective rear view of system 10. System 10 may include shelf 108 disposed behind housing 20 for supporting fuel tank 34. Shelf 108 may be fastened or welded to housing 20. Restraint 110 may be used to hold fuel tank 34 in place during use. Since system 10 is mobile, restraint 110 may be configured to tightly hold fuel tank 34 in place against spacer bracket 111 to prevent movement of fuel tank 34 when system 10 is used or transported. Spacer bracket 111 may be attached to housing 20 and configured to cradle fuel tank 34 and maintain a gap between housing 20 and fuel tank 34. Restraint 110 may partially wrap around fuel tank 34 an be attached to spacer bracket 111 or directly to housing 20 via hooks or other fasteners. In various embodiments, restraint 110 may include a chain or a strap for example. System 10 may include tightener 112 for adjusting the length of (and tension on) restraint 110 and thereby cause restraint 110 to be tightened around fuel tank 34. Tightener 112 may include a ratchet mechanism that is engaged with restraint 110. In some embodiments, tightener 112 and restraint 110 may be a ratchet strap, also known as a tie-down strap. The use of restraint 110 and tightener 112 may also accommodate fuel tanks 34 of different sizes to be mounted and secured to system 10.

Burner 36 (shown in FIG. 10) may be accessible from rear side 24 of housing 20 via access panel 114 occluding an opening defined on a rear wall of housing 20. Access panel 114 may be releasably attached to housing 20 to provide access to burner 36. The opening occluded by access panel 114 may be disposed laterally adjacent to shelf 108 and fuel tank 34.

FIG. 12 is an enlarged perspective rear view of system 10 showing access panel 114 and a burner assembly partially withdrawn from housing 20 via the opening 116 defined in the rear wall of housing 20. The rearward withdrawal of burner 36 and platform 96 may be guided by tracks 98 (shown in FIG. 10). Opening 116 may be sized to permit withdrawal of burner 36 from the housing 20 to facilitate inspection or other maintenance tasks. Access panel 114 may be lockable in the closed position by way of locking pin 118 engaging with part of housing 20 or shelf 110, and with socket 120, in which locking pin 118 may be releasably received.

Ignition wire 78, only part of which being shown in FIG. 12, may be routed through access panel 114 via suitable feedthrough to operatively couple igniter 75 with igniter button 74. Ignition wire 78, may also be routed through a channel defined by one of arms 26 or 28 of the handle assembly in the same manner as connection 46 (shown in FIG. 3). Fuel line 82, operatively coupled to burner 36, may also be routed through access panel 114.

In some embodiments, the arrangement of access panel 114 on a rear side of housing 20 may facilitate the operator's 12 visibility of important components of system 10. The position of access panel 114 in proximity to fuel tank 34 and the routing of fuel line 82 therethrough may promote the use of a relatively short fuel line 82 that is more protected and less prone to being damaged compared to having access panel 114 disposed on another side of housing 20.

The oblique orientation of tracks 98 relative to the general forward direction (shown in FIG. 10) may allow burner 36 to be moved from an in-use location that is relatively central inside of housing 20 to a withdrawn inspection/maintenance location that is laterally adjacent to fuel tank 34.

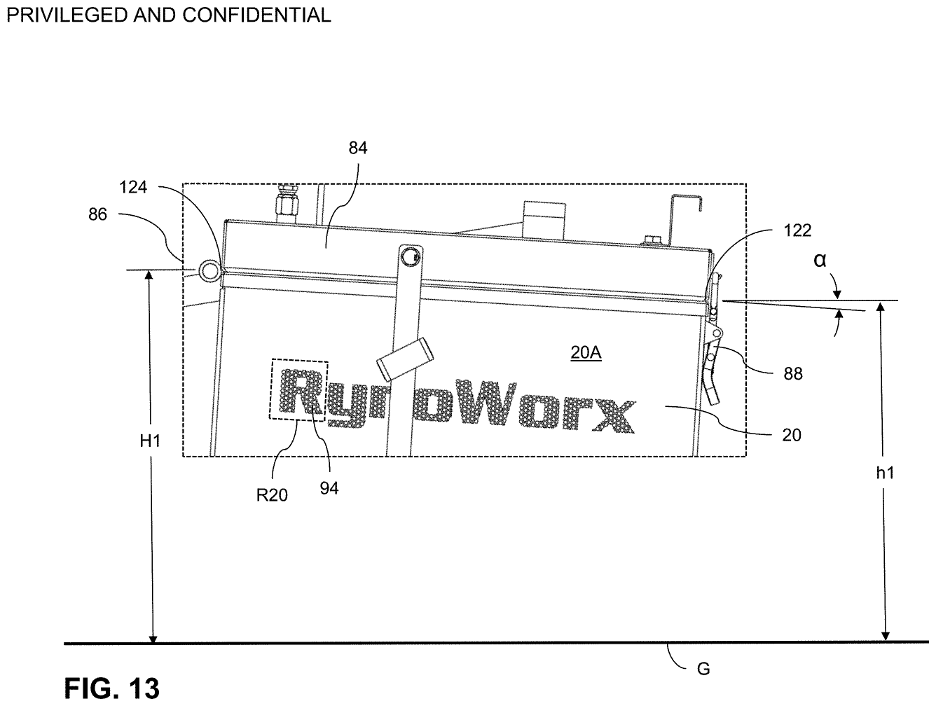

FIG. 13 is an enlarged view of region R13 of FIG. 2 showing a top portion of housing 20 including lid 84. The front side of kettle 14 disposed inside of housing 20 may have front top edge 122 and the rear side of kettle 14 may have rear top edge 124. In some embodiments of system 10, housing 20 may be configured and/or mounted so that front top edge 122 and rear top edge 124 may be disposed at the same height from ground G. However, in some embodiments, front top edge 122 may be disposed at height h1 lower than height H1 of rear top edge 124 during operation of system 10. The lower front top edge 122 may provide some overfill protection whereby any overflow of sealant from kettle 14 may spill over front top edge 122 instead of rear top edge 124 and thereby not spill on more sensitive components of system 10 that are disposed behind housing 20. In various embodiments, front top edge 122 may be lower than rear top edge 124 by a distance between 25 mm and 100 mm for example.

The different heights of front top edge 122 and rear top edge 124 may be achieved by way of kettle 14 and housing 20 being designed as such. Alternatively, kettle 14 and housing 20 may be designed to have front top edge 122 and rear top edge 124 at the same height but kettle 14 and housing 20 may be mounted (e.g., on wheels 30, 32) to have a forward-leaning orientation causing front top edge 122 to become lower than rear top edge 124 during operation of system 10 on leveled ground for example. The forward-leaning orientation may be defined by a forward tilt angle α of between 2 degrees and 15 degrees relative to ground G for example. In some embodiments, the forward tilt angle α may be about 3.5 degrees for example.

The forward-leaning orientation may also be beneficial in causing the sealant to flow toward the location of valve 126 and promote a more complete emptying of kettle 14. In some embodiments where the entire kettle 14 is not forward-leaning (e.g., α=0), a bottom wall (floor) of kettle 14 may otherwise be sloped toward the location of valve 126 to promote a more complete emptying of kettle 14.

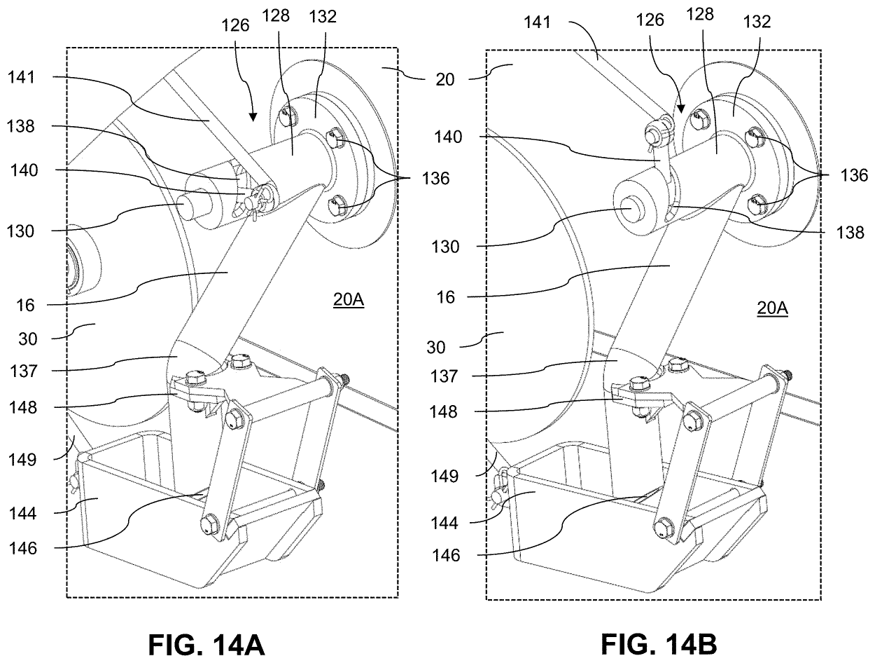

FIGS. 14A and 14B are perspective views of an exemplary dispensing valve 126 of system 10 where valve 126 is shown in the closed and open positions respectively. Valve 126 may be suitable for use on walk-behind sealant dispensing systems as illustrated herein and may also be suitable for use on other types of (e.g., stationary, trailer-mounted or truck-mounted) kettles or sealant dispensing systems. Valve 126 may be a poppet type valve. Valve 126 may have valve body 128, poppet 130 movably received inside valve body 128, first flange 132 extending outwardly from valve body 128, and dispensing spout 16. Spout 16 may include bend 137 defining a change in direction of the internal passage defined by spout 16.

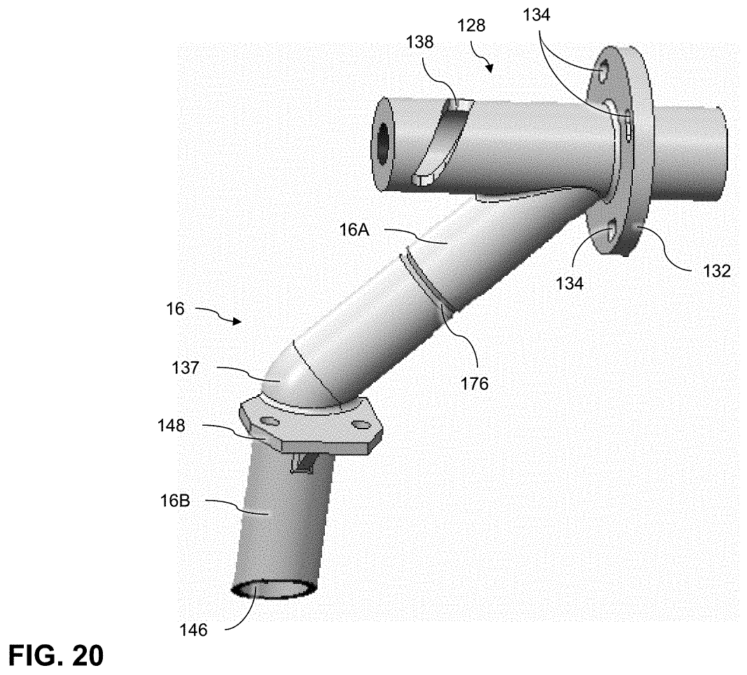

First flange 132 may be an annular flange including one or more fastener holes 134 (shown in FIG. 20) formed therethrough. Fastener holes 134 may accommodate fasteners such as bolts 136 for securing valve 126 to housing 20, which may include corresponding threaded holes. The use of bolts 136 may facilitate the installation and removal of valve 126 from housing 20 without having to rotate valve body 128. As one alternative, instead of first flange 132 and bolts 136, valve 126 may be secured to housing 20 by way of external threads (e.g., national pipe thread or “NPT”) formed on valve body 128 and engaged with an internally-threaded hole provided on housing 20 or kettle 14. As another alternative, instead of first flange 132 and bolts 136, valve body 128 may be welded to housing 20 or kettle 14 and poppet 130 may be axially removable from valve body 128 from the interior of kettle 14 due to the releasable engagement of follower 140 with poppet 130.

Poppet 130 may be axially actuatable between a closed state and an open state of valve 126 to selectively cause sealant to be dispensed from kettle 14. Any suitable means for causing actuation of poppet 130, such as a cam, feed screw or solenoid could be used to actuate poppet 130. In the embodiment shown, valve body 128 includes a cam surface in the form of cam slot 138 through which follower 140 extends. Follower 140 may include a pin that is releasably attached to (e.g., threaded into) poppet 130 and that is engaged with cam slot 138. Cam slot 138 may extend partially circumferentially and also axially (e.g., in helical manner) around poppet 130 so that rotation of follower 140 within slot 138 may cause linear axial displacement of poppet 130.

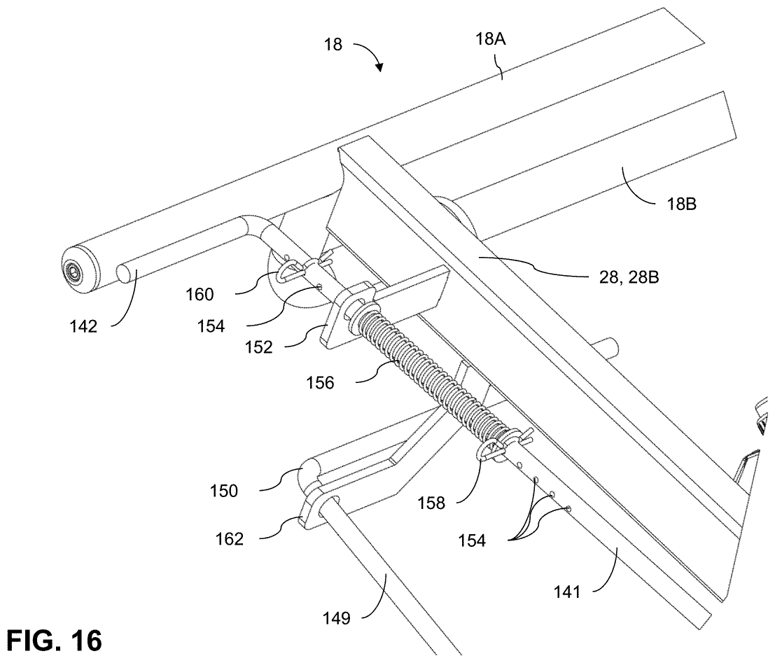

Follower 140 may be pivotally coupled to valve control rod 141 which may be attached to valve control 142 (shown in FIG. 16). Movement of valve control rod 141 may cause rotational movement of follower 140 which in turn may cause actuation of poppet 130 between the open and closed states. In some embodiments, cam slot 138 may be configured to accommodate about ¼ turn of follower 140 to cause movement between the fully open state and the fully closed state. Valve control 142 may also be positioned to cause poppet 130 to adopt an intermediate open position between the fully open state and the fully closed state to achieve a desired dispensing flow rate of sealant.

System 10 may also include spreader 144, which may also be called a “shoe”, for spreading the sealant dispensed from spout outlet 146 of spout 16. In some embodiments, spreader 144 may be bidirectional and provide a spreading function in the forward and backward directions of movement of system 10. Spreader 144 may be supported by spout 16 or by other frame of system 10. In some embodiments spout 16 may have second flange 148 extending outwardly therefrom to which spreader 144 may be mounted. Spreader 144 may be attached to second flange 148 and movable (e.g., rotatable and/or translatable) relative to spout 16. Spreader 144 may be movable between a stowed position and a deployed position via spreader control rod 149 which may be attached to spreader control 150.

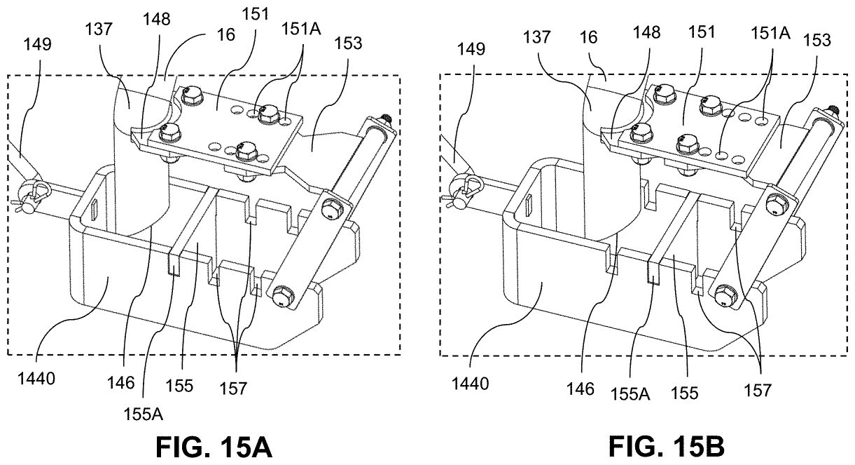

FIGS. 15A and 15B are perspective views of another exemplary reconfigurable spreader 1440 shown in two different configurations. In contrast with spreader 144, spreader 1440 may be adjustably supported by spout 16 so that a position of spreader 1440 may be adjusted either rearward or forward relative to spout 16. FIG. 15B shows a more rearward position of spreader 1440 compared to the position of spreader 1440 shown in FIG. 15A. Forward and/or rearward positional adjustment of spreader 1440 may be achieved by any suitable means. In some embodiments, adaptor 151 may be mounted between second flange 148 and mounting interface 153 of spreader 1440. It is understood that adaptor 151 may also optionally be used in conjunction with spreader 144 shown in FIGS. 14A, 14B to provide such adjustability. Adaptor 151 may include a metallic plate with multiple (e.g., sets of) holes 151A drilled therein in order to provide multiple selectable locations for attaching mounting interface 153 thereto. The attachment of mounting interface 153 with adaptor 151 may be carried out with one or more bolts as illustrated, or with other fastener(s).

Spreader 1440 may also include adjustable forward wall 155, which may be movable forward or rearward relative to the remainder of spreader 1440. Forward wall 155 may be removably engaged with the body of spreader 1440 via tabs 155A formed on opposite lateral sides of forward wall 155 and engaged with respective cooperating slots 157 defined in the body of spreader 1440. The body of spreader 1440 may include multiple (e.g., sets of) slots 157 formed therein in order to provide multiple selectable locations for positioning forward wall 155. Removing forward wall 155 from the body of spreader 1440 may include lifting forward wall 155 to release tabs 155A from a first set of slots 157 and withdrawing forward wall 155 from the body of spreader 1440. Installing forward wall 155 into the body of spreader 1440 may include inserting forward wall 155 into the body of spreader 1440 and engaging tabs 155A into desired slots 157. FIG. 15B shows a more forward position of forward wall 155 compared to the position of forward wall 155 shown in FIG. 15A.

The adjustability of spreader 1440 via adaptor 151 and the adjustability of forward wall 155 may allow operator 12 of system 10 to make adjustments based on personal preferences or on operating conditions. The adjustability of spreader 1440 and forward wall 155 may allow for adjusting the position of where the sealant is dispensed from spout 16 relative to spreader 1440. The adjustability provided may also allow for adjusting the sealant-holding capacity of spreader 1440 during use. In some situations, a configuration as shown in FIG. 15A with a shorter effective length of spreader 1440 may be preferred for filling non-linear cracks with many relatively sharp turns. In some situations, a configuration as shown in FIG. 15B with a longer effective length of spreader 1440 may be preferred for filling straighter cracks with fewer sharp turns for system 10 to follow.

FIG. 16 is a perspective view of part of system 10 showing part of handle 18, valve control 142 and spreader control 150. Valve control 142 and spreader control 150 may be proximal to handle 18 and distal of kettle 14 to facilitate actuation by operator 12. Valve control 142 may be supported by second arm 28 via first holder 152 which may include a plate through which valve control rod 141 extends. Valve control rod 141 may include a plurality of spaced apart through holes 154 disposed therealong. Valve control 142 may be manually movable through holder 152 between a valve-closed position associated with the closed state of valve 126 and corresponding to valve control 142 being retracted, and, a valve-open position associated with the open state of valve 126 and corresponding to valve control 142 being pulled toward handle 18 by operator 12.

Spring 156 may serve to bias valve 126 toward its closed state by providing a resistive force acting against a pulling force manually exerted on valve control 142 by operator 12. Accordingly, spring 156 may bias valve control 142 toward its valve-closed position. Such resistive force may be provided by spring 156 getting compressed between first holder 152 and first cotter pin 158 when valve control 142 is pulled by operator 12. The resistive force provided by spring 156 may be adjusted by movement of first cotter pin 158 to a different hole 154 along valve control rod 141. The positioning of first cotter pin 158 may be used to select a desired preloading of spring 156. Alternatively, first cotter pin 156 may be removed completely or placed in a hole 154 where spring 156 no longer applies the resistive force so as to effectively disable spring 156. Other biasing means such as a rotary spring or a coil spring disposed in tension could instead be coupled to valve 126 and/or to valve control 142 in order to bias valve 126 toward its closed position.

Valve control 142 may be lockable in a valve-open position by way of second cotter pin 160 being inserted into hole 154 disposed on a side of holder 152 opposite that of spring 156. For example, valve control 142 may be pulled by operator 12 to obtain a desired flow rate of sealant out of valve 126 and then locked at or close to that position by placing second cotter pin 160 into the appropriate hole 154 to oppose retraction of valve control 142 by spring 156. Removal of second cotter pin 160 from the appropriate hole 154 may then unlock valve control 142 and cause valve control 142 to be retracted and valve 126 to be closed. Alternatively, spring 156 may be disabled or removed completely so that operator 12 may manually adjust valve control 142 without the presence of the resistive force.

Spreader control 150 may be supported by second arm 28 via second holder 162 which may include a plate through which spreader control 150 extends. Spreader control 150 may be manually movable through holder 162 between a spreader-deployed position associated with the deployed state of spreader 144 and corresponding to spreader control 150 being retracted, and, a spreader-stowed position associated with the stowed state of spreader 144 and corresponding to spreader control 150 being pulled toward handle 18 by operator 12.

In reference briefly to FIG. 8, valve control rod 141 and spreader control rod 149 may each include turnbuckle 164 or other means to adjust their respective lengths. Such length adjustment of valve control rod 141 and spreader control rod 149 may be made to accommodate different positions of handle 18 as explained above.

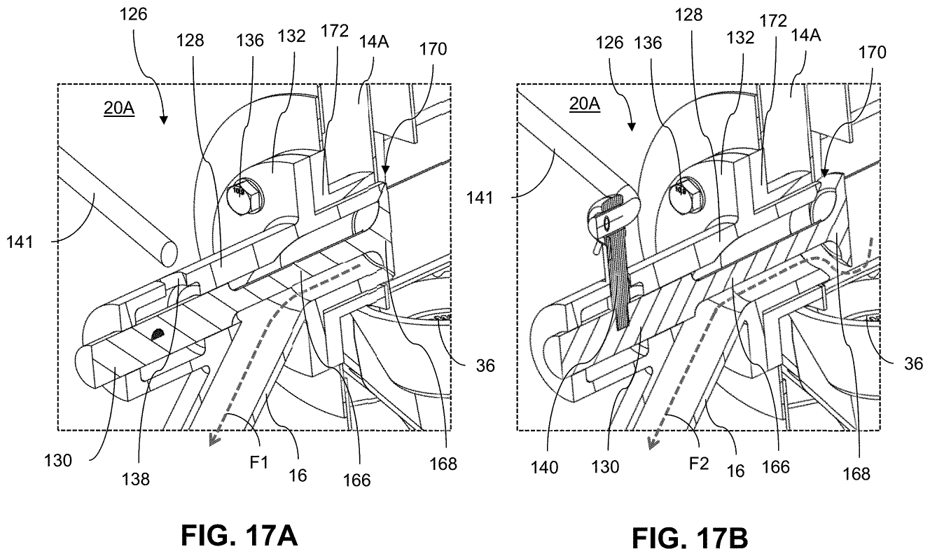

FIGS. 17A and 17B are perspective cross-sectional views of valve 126 taken along line 10-10 of FIG. 8 shown in the closed and open positions respectively. Some embodiments of system 10 may have any suitable type of sealant dispensing valve. However, valve 126 may provide operational advantages over other existing types of sealant dispensing valves. For example, the configuration of valve 126 within system 10 may allow liquid sealant to readily drain from within valve body 128 as shown by arrow F1 in FIG. 17A so that when system 10 is not used, valve body 128 may be mostly empty of sealant material that could cool, solidify within valve body 128 and cause valve 126 to be stuck. Some existing sealant dispensing valves retain some sealant material after use and require significant pre-heating time in order to melt the sealant within the valve to resume operation of the valve and the associated sealant dispensing system after a period of inactivity. In some embodiments of valve 126, the lack of, or little amount of sealant material retained in valve 126 may eliminate or reduce the need for such pre-heating time of valve 126 to starting using system 10 after system 10 has cooled off.

Valve 126 may be a poppet valve including poppet 130 movable within valve body 128. Poppet 130 may include stem 166 and head 168. Follower 140 may be attached to poppet 130 by threaded engagement to cause rotational and axial movement of poppet 130 within valve body 128. Head 168 may cooperate with a valve seat defined on valve body 128 to define inlet port 170. In some embodiments, an angle of the contact interface between the valve seat and head 168 may be about 45° from an axial direction of movement of poppet 130 but other angles may also be suitable. FIG. 17A shows inlet port 170 being closed and FIG. 17B shows inlet port being opened and sealant material being permitted to flow out of kettle 14 along arrow F2.

One part of valve 126 including inlet port 170 may be disposed inside of housing 20 and another part of valve 126 including follower 140 and part of stem 166 may be disposed outside of housing 20. For example, inlet port 170 and head 168 may be disposed inboard of housing wall 20A. In some embodiments, inlet port 170 may be substantially flush with kettle wall 14A. In some embodiments, inlet port 170 may be inboard of kettle wall 14A. In some embodiments, some or substantially all of head 168 may be disposed inside kettle 14 (i.e., inboard of kettle wall 14A). The positioning of inlet port 170 proximate of or within melted sealant inside kettle 14 may also reduce the need for separate pre-heating of valve 126 during start-up of system 10.

Valve 126 may be attached to housing 20 via sleeve 172 that may be attached to housing 20 and provide an interface for installing valve 126. Sleeve 172 may be welded or fastened to housing 20. Valve 126 may be received into sleeve 172 and fastened to sleeve 172 via bolts 136. The installation of valve 126 using bolts 136 may facilitate the removal and installation of valve 126 from system 10 for replacement or maintenance such as cleaning for example.

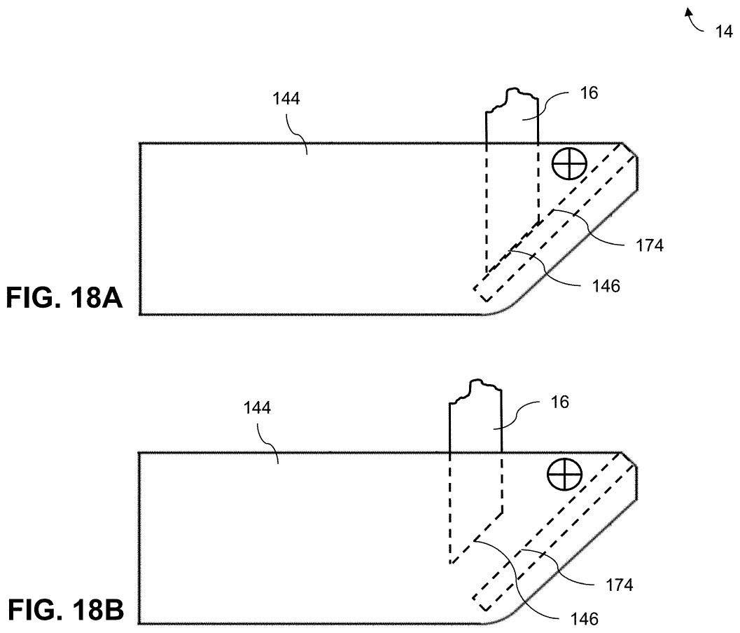

FIGS. 18A and 18B are schematic side elevation views of spout 16 and spreader 144 respectively closing and opening spout outlet 146. Spreader 144 may be operable as a secondary valve (to valve 126 or to another type of valve upstream of spout outlet 146) to stop or hinder leakage of sealant out of spout outlet 146 when the use of system 10 is stopped or when system 10 is transported for example.

When spreader 144 is in the stowed position (e.g., lifted from ground G) as shown in FIG. 18A, an optional closing surface 174 of spreader 144 may be in contact with spout outlet 146 and substantially close spout outlet 146. Alternatively, when spreader 144 is in the deployed position (e.g., engaged with ground G) as shown in FIG. 18B, closing surface 174 of spreader 144 may be removed from spout outlet 146 so that spout outlet 146 may be open and sealant may be dispensed. In other words, closing surface 174 of spreader 14 may be selectively engageable with spout outlet 146.

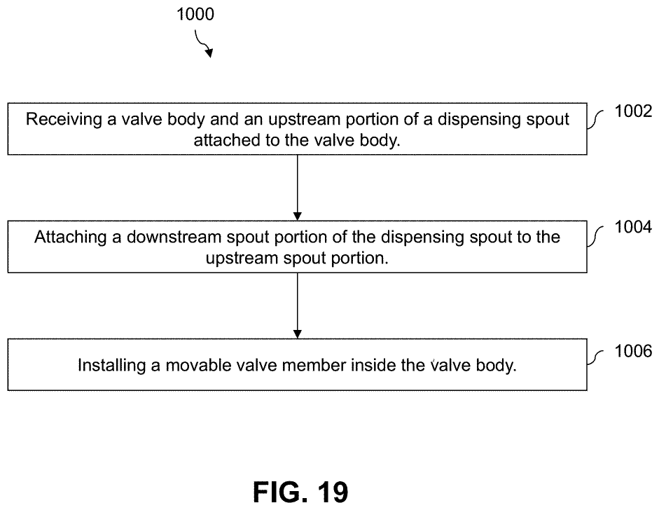

FIG. 19 is a flowchart of a method 1000 of making dispensing valve 126 describe above or another valve.

FIG. 20 is a perspective view of part of valve 126. In reference to FIGS. 17A, 17B, 19 and 20, method 1000 may include: receiving valve body 128 and upstream portion 16A (shown in FIG. 20) of dispensing spout 16 attached to valve body (see block 1002); attaching downstream spout portion 16B (shown in FIG. 20) of dispensing spout 16 to upstream spout portion 16A (see block 1004); and installing a movable valve member (e.g., poppet 130) inside valve body 128 (see block 1006).

Valve body 128 and upstream spout portion 16A may be machined, or cast together as a single casting. The single casting may include first flange 132. In some embodiments where valve body 128 and upstream spout portion 16A are cast together, some machining may be performed on some surfaces. For example, an inner bore and a valve seat of valve body 128 may be reamed/machined to desirable tolerances for accommodating poppet 130 therein. Poppet 130 may be cast, machined, inserted inside valve body 128 and assembled with follower 40. In some embodiments, external surfaces of valve body 128 and dispensing spout 16 may be (e.g., powder-) coated.

Downstream spout portion 16B may be cast separately from valve body 128 and upstream spout portion 16A and subsequently assembled with upstream spout portion 16A by any suitable means such as brazing, or welding along seam 176 for example using a suitable fixture (jig) to orient downstream spout portion 16B relative to upstream spout portion 16A. Downstream spout portion 16B may be cast together with second flange 148. Some machining of downstream spout portion 16B may be done after casting. Downstream spout portion 16B may including bend 137. In some embodiments, some or all components of valve 126 (e.g., valve body 128, first flange 132, upstream spout portion 16A, downstream spout portion 16B, second flange 148 and poppet 130) may be made from steel such as stainless steel or other metallic material(s). Fastener holes 134 in first flange 132 and other fastener holes in second flange 148 may be formed (e.g., drilled) after casting.

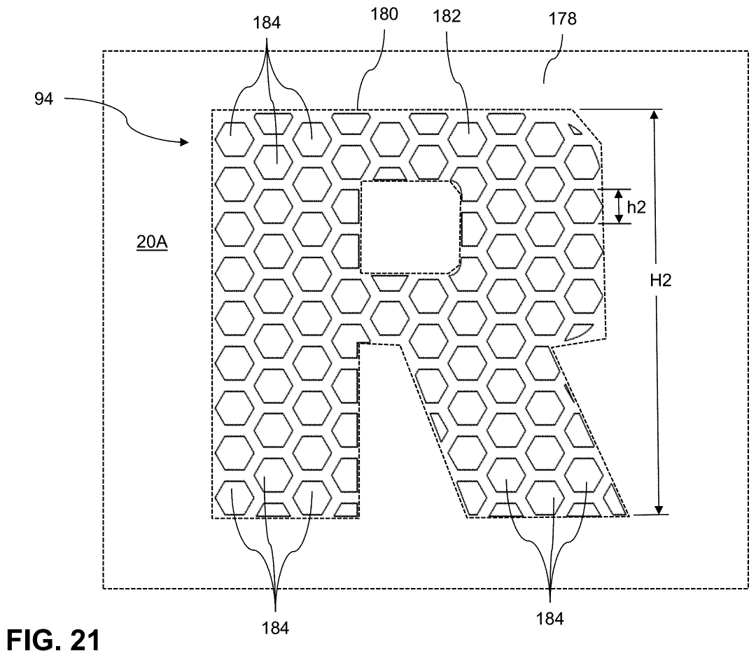

FIG. 21 is an enlarged view of region R20 of FIG. 13. FIG. 21 shows part of housing wall 20A, which may have the form of a plate or sheet of a metallic material, with part of vent 94 defined therein. Vent 94 may allow combustion gas generated by burner 36 to be exhausted from housing 20. However, vent 94 may also be configured to mitigate heat loss from kettle 14 and prevent some foreign objects from entering housing 20. In some embodiments, vent 94 or part thereof may be configured to define a graphical indication or a textual indication on housing 20.

Housing wall 20A may include unperforated region 178 outside outline 180 of the graphical or textual indication, and perforated region 182 inside outline 180 of the graphical or textual indication. Outline 180 may not be explicitly shown on the plate or sheet but may represent a boundary of the graphical or textual indication. Perforated region 182 may include a plurality of spaced apart perforations 184 defining a honeycomb or other pattern filling an area inside outline 180 of the graphical or textual indication. The graphical or textual indication may include a company logo, graphic, (e.g., safety) symbol and/or one or more textual characters in any suitable font. The graphical or textual indication may include one or more textual characters of a same or different font sizes. The font size as referenced herein is intended to represent the overall size (generally height) of a font shown on a plate or sheet. The font size can be measured in a point (pt) size, which is the vertical measurement of the lettering where 72 points is equal to one inch (25.4 mm).

In various embodiments, perforations 184 may be polygonal (e.g., hexagonal) or of other shape(s). In some embodiments, perforations 184 may be of substantially uniform size and shape and some perforations 184 disposed near or intersecting outline 180 may be truncated. In some embodiments, all six sides of perforations 184 may be of substantially equal length.

Perforations 184, may be sized to have a perforation height h2 that is between 5% and 10% of a character height H2 in case of a textual character, or of outline 180 in case of a graphical indication. In some embodiments, perforations 184 may be sized to provide a desired visual appearance while considering one or more other factors such as venting performance through vent 94, mitigating heat loss and maintaining structural integrity of housing wall 20A. In various embodiments, a perforated area may occupy between 25% and 75% of the area of perforated region 182 within outline 180.

It is understood that graphical or textual indications produced by way of perforations 184 may be disposed on plates or sheets elsewhere on system 10 including on instrument panel 40 and/or arms 26, 28 for example. The plates or sheets may be made from a metallic material such as an aluminum alloy or steel. Perforations 184 may be formed by any suitable material-removal process such as (e.g., laser, die) cutting or machining. In some embodiments, perforations 184 may be formed directly into housing wall 20A. Alternatively, a cut-out of outline 180 may be made in housing wall 20A and a separate part (e.g., patch) containing perforations 184 may be inserted into the cut-out, or placed behind housing wall 20A to cover the cut-out, and attached to housing wall 20A by welding for example.

The embodiments described in this document provide non-limiting examples of possible implementations of the present technology. Upon review of the present disclosure, a person of ordinary skill in the art will recognize that changes may be made to the embodiments described herein without departing from the scope of the present technology. Modifications could be implemented by a person of ordinary skill in the art in view of the present disclosure, which modifications would be within the scope of the present technology.

1. A walk-behind sealant dispensing system comprising:
a kettle for holding and dispensing sealant, the kettle having a front side facing a general direction of movement during operation of the system and a rear side opposite the front side;
a handle for manually maneuvering the system by an operator, the handle being disposed behind the kettle at a position for handling by the operator in a standing position; and
a poppet valve actuatable between a closed state and an open state to selectively cause sealant to be dispensed from the kettle.

2. The system as defined in claim 1, comprising a dispensing spout disposed downstream of a movable poppet of the poppet valve, the dispensing spout including an upstream spout portion welded to a downstream spout portion.

3. The system as defined in claim 2, wherein the downstream spout portion includes a bend.

4. The system as defined in claim 1, wherein the poppet valve includes a flange extending outwardly from a valve body of the poppet valve, the flange including a fastener hole formed therethrough.

5. The system as defined in claim 1, comprising:
a dispensing spout for dispensing sealant from the poppet valve, the dispensing spout having a spout outlet; and
a spreader for spreading the sealant dispensed from the spout outlet, the spreader being movable between a stowed position where the spreader closes the spout outlet and a deployed position where the spreader opens the spout outlet.

6. The system as defined in claim 5, wherein the spreader is supported by the dispensing spout.

7. The system as defined in claim 1, comprising:
a dispensing spout for dispensing sealant from the poppet valve, the dispensing spout having a spout outlet; and
a spreader for spreading the sealant dispensed from the spout outlet, the spreader being adjustably attached to the dispensing spout.

8. The system as defined in claim 1, comprising:
a dispensing spout for dispensing sealant from the poppet valve, the dispensing spout having a spout outlet; and
a spreader for spreading the sealant dispensed from the spout outlet, the spreader having a forward wall adjustably attached to a body of the spreader.

9. The system as defined in claim 1, wherein the poppet valve is biased toward the closed state of the poppet valve.

10. The system as defined in claim 1, comprising a valve control operatively coupled to cause actuation of the poppet valve, wherein:
the valve control is manually actuatable between a first position associated with the closed state of the poppet valve and a second position associated with the open state of the poppet valve; and
the valve control is biased toward the first position associated with the closed state of the poppet valve.

11. The system as defined in claim 10, comprising a spring biasing the valve control toward the first position, a biasing force provided by the spring being adjustable.

12. The system as defined in claim 10, wherein the valve control is lockable in the second position associated with the open state of the poppet valve.

13. The system as defined in claim 10, wherein the valve control is disposed proximal the handle and distal of the kettle.

14. The system as defined in claim 1, wherein:
the kettle is disposed inside a housing; and
the valve include a valve body and a poppet movably received in the valve body to open and close an inlet port of the dispensing valve, a head of the poppet is disposed inside the kettle.

15. The system as defined in claim 14, comprising a gas burner is disposed inside the housing for heating the kettle.

16. A crack sealant dispensing valve for a sealant dispensing system, the dispensing valve including:
a valve body;
a flange extending outwardly from the valve body, the flange including a fastener hole formed therethrough;
a poppet movably received in the valve body to open and close a port of the dispensing valve; and
a dispensing spout for fluid communication with the port.

17. The valve as defined in claim 16, wherein the dispensing spout includes a bend.

18. The valve as defined in claim 16, wherein the dispensing spout includes an upstream spout portion and a downstream spout portion, the downstream spout portion being welded to the upstream spout portion.

19.-21. (canceled)

22. A sealant dispensing system comprising:
a housing;
a kettle for holding and dispensing sealant, the kettle disposed inside the housing; and
a poppet valve actuatable between a closed state and an open state to selectively cause sealant to be dispensed from the kettle, the poppet valve including a valve body and a flange extending outwardly from the valve body, the flange including a fastener hole formed therethrough, the poppet valve being attached to the housing via a fastener extending through the fastener hole and engaged with the housing.

23. The system as defined in claim 22, comprising a dispensing spout disposed downstream of a poppet of the poppet valve, the dispensing spout including an upstream spout portion welded to a downstream spout portion, the downstream spout portion including a bend.

24.-123. (canceled)
